(19) United States
(12) Patent Application Publication
(10) Pub. No.: US 2004/0156978 A1
(43) Pub. Date: Aug. 12, 2004

(54) Black magic licorice extract

(76) Inventor: Doris Lorraine Buck, Laguna Hills, CA (US)

Correspondence Address: DORIS LORRAINE BUCK, DORIS LORRAINE FOODS, INC., 11-A VIA CASTILLA, LAGUNA HILLS, CA, 92653, US

(21) Appl. No.: 10/139,539

(22) Filed: Dec. 2, 2002

Related U.S. Application Data
(60) Provisional application No. 60/289,291, filed on May 7, 2001.

(51) Int. Cl. A23L 1/221

(52) U.S. Cl. 426/650

(57) ABSTRACT

“Black Magic” Licorice Extract is a unique, new extract flavoring with exceptional appeal for licorice lovers. Licorice is a European Leguminous plant and the extract is made from the roots which are 3 to 4 feet long, ¼ to 1 inch in diameter; soft, flexible, fibrous, internally of a bright, yellow color. The hard and semi-vitreous sticks of paste (naturally black in color and possessed of a sweet, somewhat astringent taste) known as licorice paste or black sugar, are the thickened juice of the root. Preparation of the juice is done by boiling crushed and ground roots. Rootstocks contain glycyrrhizin, in its pure form a colorless, very sweet, glycerine glycoside (many times sweeter than table sugar).and glycyrrhetinic acid. “Black Magic” Licorice Extract has many versatile uses: a soda flavoring, sweetener for foods and drinks, a natural laxative, and expectorant.

### LICORICE CONCENTRATE

Formula 1+6

| | | Unit Cost | |
|---|---|---|---|
| | Pounds | per lb. | Extension |
| Sugar | 45.00 | 0.14 | 6.30 |
| Anise Oil (Globe West) | 0.30 | 2.75 | .83 |
| Foaming Agent (Ritter) | 1.50 | 7.75/gal | 1.16 |
| | | 0.775/lb | |
| Burnt Sugar Shade | 0.25 | 4.95 | 1.24 |
| (Globe West) | | | |
| Ketrol F (Kelco) | 0.10 | 2.50 | 0.25 |
| Licorice Extract | 4.50 | 1.35 | 6.08 |
| (Globe West) | | | |
| Water | 48.35 | — | — |
| | 100.00 | | 15.86 |

100 lbs of the above formula will be used to dilute with 600 lbs of soda water for a finished product of 700 lbs.

Formula 1+5

| | | Unit Cost | |
|---|---|---|---|
| | Pounds | per lb. | Extension |
| Sugar | 38.75 | 0.14 | 5.40 |
| Anise | 0.26 | 2.75 | 0.71 |
| [symbol] in [symbol] nt | 1.29 | 7.75/gal | 1.00 |
| | | 0.775/lb | |
| Burnt sugar [symbol] | 0.21 | 4.95 | 1.06 |
| Keltrol [symbol] | 0.09 | 2.50 | 0.21 |
| Licorice Extract | 3.86 | 1.35 | 5.21 |
| Water | 55.54 | — | — |
| | 100.00 | | 13.59 |

100 lbs of the above formula will be used to dilute with 500 lbs of soda water for a finished product of 600 lbs.

What I claim as my invention is:

1. “BLACK MAGIC” Licorice Extract for use as a soda flavoring, a unique, new and different soft drink with exceptional appeal for licorice lovers

2. “BLACK MAGIC” Licorice Extract to be used in separate form as a licorice concentrate sweetener in all types of foods, liquors, coffee, teas and other liquids.

3. “BLACK MAGIC” Licorice Extract to be used as a natural laxative, expectorant, and cough alleviate.
